(19) United States
(12) Patent Application Publication
(10) Pub. No.: US 2024/0086990 A1
(43) Pub. Date: Mar. 14, 2024

(54) PURCHASING FACTOR ESTIMATION DEVICE, PURCHASING FACTOR ESTIMATION SYSTEM, PURCHASING FACTOR ESTIMATION METHOD, AND STORAGE MEDIUM ON WHICH PURCHASING FACTOR ESTIMATION PROGRAM IS STORED

(71) Applicant: NEC Corporation, Minato-ku, Tokyo (JP)

(72) Inventors: Makoto TAKAMOTO, Tokyo (JP); Daniel ONORO RUBIO, Heidelberg (DE)

(73) Assignee: NEC Corporation, Minato-ku, Tokyo (JP)

(21) Appl. No.: 18/273,758

(22) PCT Filed: Mar. 31, 2021
(86) PCT No.: PCT/JP2021/013866

§ 371 Date: Jul. 21, 2023

(51) Int. Cl. G06Q 30/0601

(52) U.S. Cl. CPC G06Q 30/0631

(57) ABSTRACT

A purchasing factor estimation device includes: an acquisition unit that acquires person attribute information relating to a first person and product attribute information relating to a first product; an estimation unit that, on the basis of the person attribute information and the product attribute information, uses an estimation model to estimate the first person's degree of interest in the first product; and an output unit that outputs the first person's estimated degree of interest and an estimation reason therefor. The factors behind the purchase of a product by a customer are determined as a result of generating the estimation model by learning the relationship among person attribute information relating to a second person, product attribute information relating to a second product, line of sight information of the second person in relation to the second product, and the second person's degree of interest in the second product.

### TECHNICAL FIELD

The present invention relates to a purchasing factor estimation device, a purchasing factor estimation system, a purchasing factor estimation method, and a storage medium storing a purchasing factor estimation program.

### BACKGROUND ART

For a business operator who sells products to customers, for example, it is very important to analyze what attribute a person has and what attribute a person shows an interest in a product in formulating a business strategy. Therefore, a technology for supporting such analysis is expected.

As a technique related to such a technique, PTL 1 discloses an estimation device that estimates a degree of preference between products possessed by a user with respect to product attributes.

PTL 2 discloses a specifying device that specifies a product attractive to a user.

### CITATION LIST

### Patent Literature

PTL 1: WO 2020/170287 A
PTL 2: JP 2016 004551 A

### SUMMARY OF INVENTION

### Technical Problem

However, with the techniques disclosed in PTLs 1 and 2, it is not possible to estimate a factor that a customer has purchased a product.

A main object of the present invention is to identify a purchasing factor of a product.

### Solution to Problem

A purchasing factor estimation device according to an aspect of the present invention includes: an acquisition means configured to acquire person attribute information on a first person and product attribute information on a first product; an estimation means configured to estimate a degree of interest of the first person in the first product using an estimation model based on the person attribute information on the first person and the product attribute information on the first product; and an output means configured to output the estimated degree of interest of the first person and an estimation reason. The estimation model is generated by learning a relationship among person attribute information on a second person, product attribute information on a second product, line of sight information of the second person for the second product, and a degree of interest of the second person in the second product.

From another viewpoint of achieving the above object, a purchasing factor estimation method according to an aspect of the present invention is a purchasing factor estimation method performed by an information processing device, the method including: acquiring person attribute information on a first person and product attribute information on a first product; estimating a degree of interest of the first person in the first product using an estimation model based on the person attribute information on the first person and the product attribute information on the first product; and outputting the estimated degree of interest of the first person and an estimation reason. The estimation model is generated by learning a relationship among person attribute information on a second person, product attribute information on a second product, line of sight information of the second person for the second product, and a degree of interest of the second person in the second product.

From a further viewpoint of achieving the above object, a purchasing factor estimation program according to an aspect of the present invention executes: acquiring person attribute information on a first person and product attribute information on a first product; estimating a degree of interest of the first person in the first product using an estimation model based on the person attribute information on the first person and the product attribute information on the first product; and outputting the estimated degree of interest of the first person and an estimation reason. The estimation model is generated by learning a relationship among person attribute information on a second person, product attribute information on a second product, line of sight information of the second person for the second product, and a degree of interest of the second person in the second product.

Further, the present invention can also be achieved by a computer-readable non-volatile storage medium in which a purchasing factor estimation program (computer program) is stored.

### Advantageous Effects of Invention

According to the present invention, it is possible to identify a factor that a customer has purchased a product, and thus it is possible to contribute to expansion of sales of the product.

### BRIEF DESCRIPTION OF DRAWINGS

FIG. 1 is a block diagram illustrating a configuration of a purchasing factor estimation device 10 according to a first example embodiment of the present invention.

FIG. 2 is a diagram illustrating movement of a line of sight of a person for a product displayed on a product shelf, the movement being indicated by line of sight information 103 according to the first example embodiment of the present invention.

FIG. 3 is a diagram illustrating a graph included in an estimation model 120 according to the first example embodiment of the present invention.

FIG. 4 is a flowchart illustrating an operation in which the purchasing factor estimation device 10 according to the first example embodiment of the present invention generates the estimation model 120 (performs machine learning).

FIG. 5 is a diagram illustrating a mode in which an output unit 14 according to the first example embodiment of the present invention displays an estimation result on a display screen 200.

FIG. 6 is a flowchart illustrating an operation in which the purchasing factor estimation device 10 according to the first example embodiment of the present invention estimates the degree of interest of the estimation target person for the estimation target product.

FIG. 7 is a block diagram illustrating a configuration of a purchasing factor estimation system 10A according to a modification of the first example embodiment of the present invention.

FIG. 8 is a block diagram illustrating a configuration of a purchasing factor estimation device 30 according to a second example embodiment of the present invention.

FIG. 9 is a block diagram illustrating a configuration of an information processing device 900 capable of achieving the purchasing factor estimation device according to each example embodiment of the present invention.

### EXAMPLE EMBODIMENT

Hereinafter, example embodiments of the present invention will be described in detail with reference to the drawings.

### First Example Embodiment

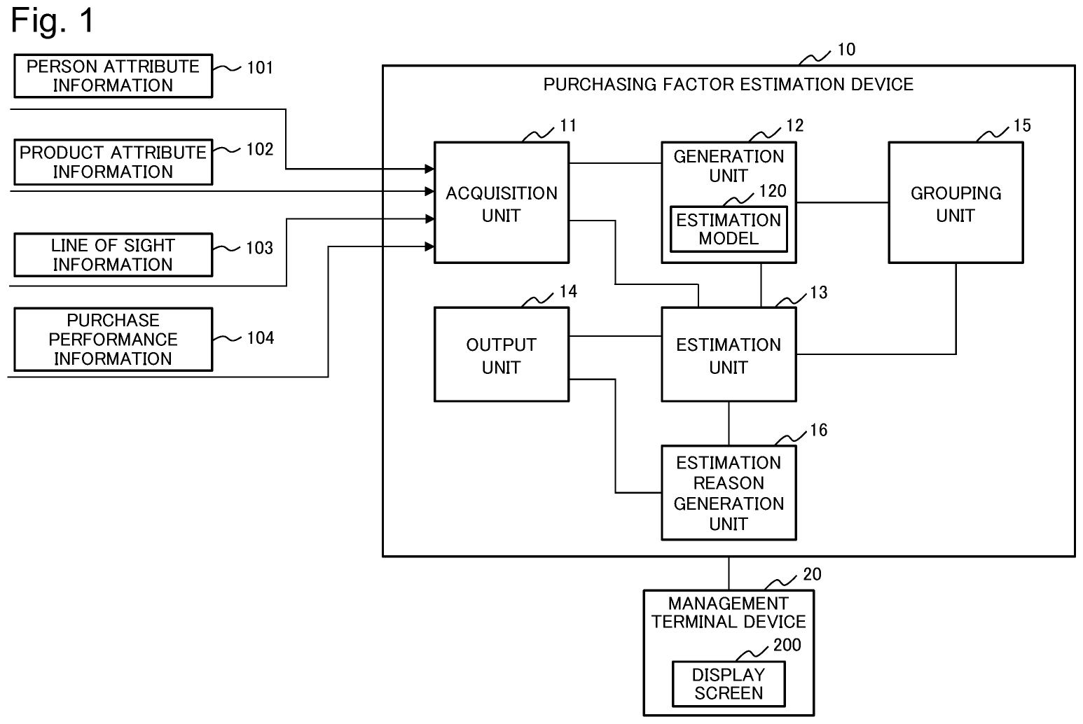

FIG. 1 is a block diagram illustrating a configuration of a purchasing factor estimation device 10 according to a first embodiment of the present invention. The purchasing factor estimation device 10 according to the present example embodiment is a device that estimates the degree of interest of the person for the product based on the information regarding the attribute of the estimation target person (customer) and the information regarding the attribute of the estimation target product, and outputs the estimation reason (that is, the purchasing factor).

A management terminal device 20 is communicably connected to the purchasing factor estimation device 10. The management terminal device 20 is, for example, a personal computer or another information processing device used when a user using the purchasing factor estimation device 10 inputs information to the purchasing factor estimation device 10 or confirms information output from the purchasing factor estimation device 10. The management terminal device 20 includes a display screen 200 that displays the estimation result of the degree of interest of the target person for the target product output from the purchasing factor estimation device 10, the estimation reason, and the like.

The purchasing factor estimation device 10 includes an acquisition unit 11, a generation unit 12, an estimation unit 13, an output unit 14, a grouping unit 15, and an estimation reason generation unit 16. The acquisition unit 11, the generation unit 12, the estimation unit 13, the output unit 14, and the grouping unit 15 are examples of an acquisition means, a generation means, an estimation means, an output means, and a grouping means in order.

Next, an operation in which the purchasing factor estimation device 10 according to the present example embodiment generates or updates the estimation model 120 for estimating the degree of interest of the target person for the target product by machine learning, and an operation in which the degree of interest of the target person for the target product is estimated using the generated or updated estimation model 120 will be described in order.

<Operation of Generating (Updating) Estimation Model 120>

First, an operation in which the purchasing factor estimation device 10 according to the present example embodiment generates or updates the estimation model 120 for estimating the degree of interest of the target person for the target product by machine learning will be described.

The acquisition unit 11 acquires, for example, person attribute information 101, product attribute information 102, line of sight information 103, and purchase performance information 104 registered in an external computer device, a database, or the like (not illustrated) as input information for learning used to generate or update the estimation model 120.

The person attribute information 101 is information indicating an attribute related to a learning target person (second person) registered in the database or the like. The person attribute information 101 includes, for example, at least one of age, sex, occupation, income, nationality, family structure, hobby, place of residence, body shape, drinking, smoking, preference, and behavior history regarding the person. The occupation includes, for example, white color or blue color. The family structure indicates, for example, the presence or absence of a roommate (whether the resident lives alone), whether the resident is a married person, the presence or absence of a child, and the like. The body shape indicates, for example, a body weight, a numerical value of a body mass index (BMI), whether the user is fat or thin, and the like. The items included in the person attribute information 101 are not limited to the above items.

The product attribute information 102 is information indicating an attribute related to a learning target product (second product) registered in the database or the like. The product attribute information 102 includes, for example, at least one of product name, product identifier, type, quantity, price, appearance, manufacturer, seller, content, nutrient component, raw material, release time, and display position on a product shelf, regarding the product. The items included in the product attribute information 102 are not limited thereto.

The line of sight information 103 is, for example, information indicating movement of a line of sight of a learning target person for a learning target product displayed on a product shelf, stay time of the line of sight, and the like (visual recognition pattern). For example, the line of sight information includes at least one of a visual recognition time, the number of times of visual recognition, a visual recognition rate, and the like, but is not limited thereto as long as the line of sight information is information related to the line of sight. As will be described later, the line of sight information 103 is information that can be used as a reference when estimating the degree of interest (level of interest) of the learning target person in the learning target product.

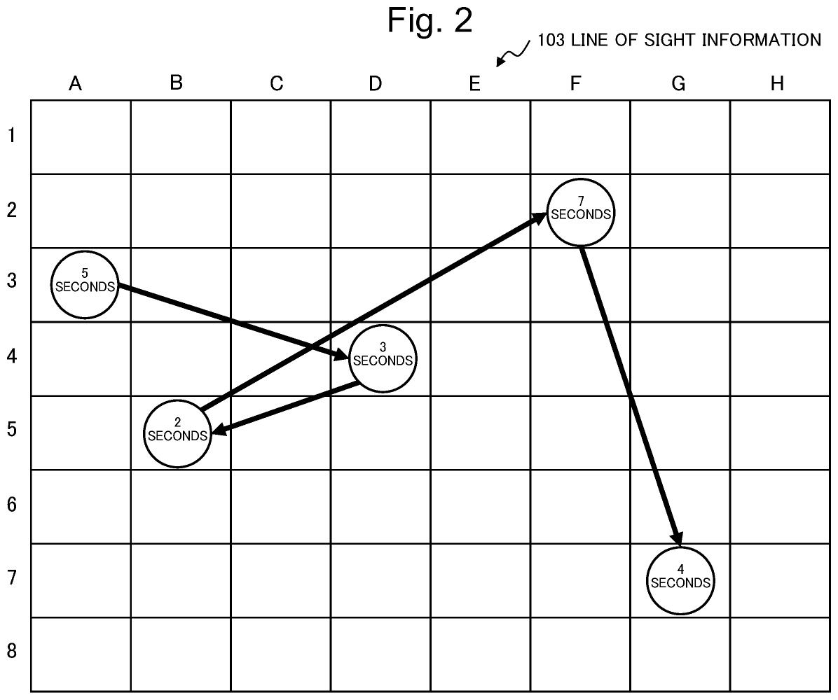

FIG. 2 is a diagram illustrating movement of the line of sight of a learning target person for a learning target product displayed on a product shelf, the movement being indicated by the line of sight information 103 according to the present example embodiment. In FIGS. 2, 1 to 8 in the vertical direction on the paper surface and A to H in the horizontal direction on the paper surface are values assigned to the product shelf in order to represent the position of the product on the product shelf by two-dimensional coordinates. Note that, in the following description, for example, a product displayed at coordinates A1 will be referred to as a product A1.

According to the line of sight information 103 illustrated in FIG. 2, the learning target person first looks at a product A3 for 5 seconds and then moves his/her line of sight to a product D4. Next, the person looks at the product D4 for 3 seconds, and then moves the line of sight to a product B5. Next, the person looks at the product B5 for two seconds, and then moves the line of sight to a product F2. Next, the person looks at the product F2 for 7 seconds, and then moves the line of sight to a product G7. The person then looks at the product G7 for four seconds.

The above-described line of sight information 103 can be acquired, for example, by using an existing technology of estimating a line of sight of a person from eye movement of the person indicated by an image captured by a monitoring camera installed near a product shelf and capable of capturing the eye movement of the person looking at the product shelf. In the existing technology, for example, a position of a viewpoint of a person is estimated from an image by a monitoring camera capable of acquiring a positional relationship among a product shelf, a monitoring camera, and the person.

The order and time that the learning target person has looked at the learning target product, which are indicated by the line of sight information 103, indicate the degree of interest of the person in the product. For example, in general, a product looked at by a certain person earlier or a product looked at by the person for a long time is considered to be a product of high interest to the person. For example, according to the line of sight information 103 illustrated in FIG. 2, the product A3 looked at by the person for 5 seconds first and the product F2 looked at by the person for 7 seconds are estimated to be products of higher interest to the person than other products.

The purchase performance information 104 is information indicating whether the learning target person has purchased the learning target product. When a person purchases a product, it can be said that the product is a product of high interest to the person. Therefore, similarly to the line of sight information 103 described above, the purchase performance information 104 is information indicating the degree of interest of the learning target person in the learning target product.

The generation unit 12 generates or updates the estimation model 120 by performing learning based on the person attribute information 101 regarding the learning target person, the product attribute information 102 regarding the learning target product, the line of sight information 103 of the person for the product, and the purchase performance information 104 of the product by the person described above.

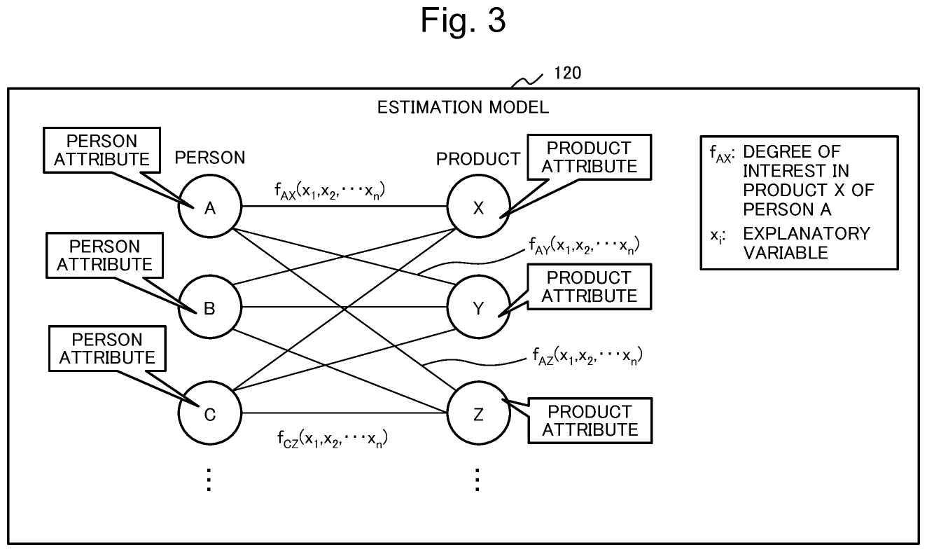

FIG. 3 is a diagram illustrating a graph indicating a degree of interest of a certain person in a certain product included in the estimation model 120 according to the present example embodiment.

In FIG. 3, nodes A to C and the like represented by circles represent persons, and nodes X to Z and the like represent products. The nodes A to C and the like include an attribute of each person indicated by the person attribute information 101, and the nodes X to Z and the like include an attribute of each product indicated by the product attribute information 102.

In FIG. 3, a line (edge) connecting a node of a person and a node of a product represents a degree of interest of the person in the product. For example, the degree of interest of the person A in the product X is expressed as a function f_{AX} (x₁, x₂, . . . , xₙ), and the degree of interest of the person C in the product Z is expressed as a function f_{CZ} (x₁, x₂, . . . , xₙ). Here, n is an arbitrary natural number, and x₁ (i is any one of 1 to n natural numbers) is n explanatory variables used when the degree of interest of a certain person in a certain product is estimated. The explanatory variable xᵢ is a variable related to attributes of a person and a product. Note that, in the following description, the explanatory variable xᵢ may be collectively referred to as an explanatory variable x. The function f_{AX}, the function f_{CZ}, and the like may be collectively referred to as a function f.

The generation unit 12 determines the explanatory variable x based on the person attribute information 101, the product attribute information 102, the line of sight information 103, and the purchase performance information 104 acquired by the acquisition unit 11. The generation unit 12 generates or updates the estimation model 120 by learning the degree of interest of the person in the product, which is indicated by the line of sight information 103 and the purchase performance information 104, as a label.

For example, it is assumed that the person attribute information 101 indicates that the person A in FIG. 3 is obese, and the product attribute information 102 indicates that the product X is a diet-related product including a component effective for dieting. Then, it is assumed that the line of sight information 103 indicates that the person A has looked at the product X in front of the product shelf for a long time, and the purchase performance information 104 indicates the performance of purchasing the product X by the person A. In this case, the generation unit 12 determines that the person is obese and the product is a diet-related product as the explanatory variable x, and generates or updates the function f_{AX} including the explanatory variable x.

The generation unit 12 updates the function f including the function f_{AX} such that the degree of contribution of the explanatory variable x indicating that the person is obese and the product is a diet-related product increases as the cases indicating that the obese person has a high interest in the diet-related product, which are indicated by the line of sight information 103 and the purchase performance information 104, increase. However, the degree of contribution is an index indicating weighting when the degree of interest of the person in the product is estimated.

Each of the persons A to C and the like exemplified in FIG. 3 may not be one person, but may be, for example, a group including a plurality of persons having similar tendencies of degree of interests in a product. The grouping unit 15 illustrated in FIG. 1 groups (performs clustering) a plurality of persons having similar tendencies of degrees of interest for a product based on the degrees of interest of the learning target persons. For example, the grouping unit 15 may group a plurality of persons having similar attributes indicated by the person attribute information 101.

The grouping unit 15 notifies the generation unit 12 of the result of grouping the persons as described above. The generation unit 12 may manage a plurality of persons included in the estimation model 120 as one group based on the grouping result by the grouping unit 15.

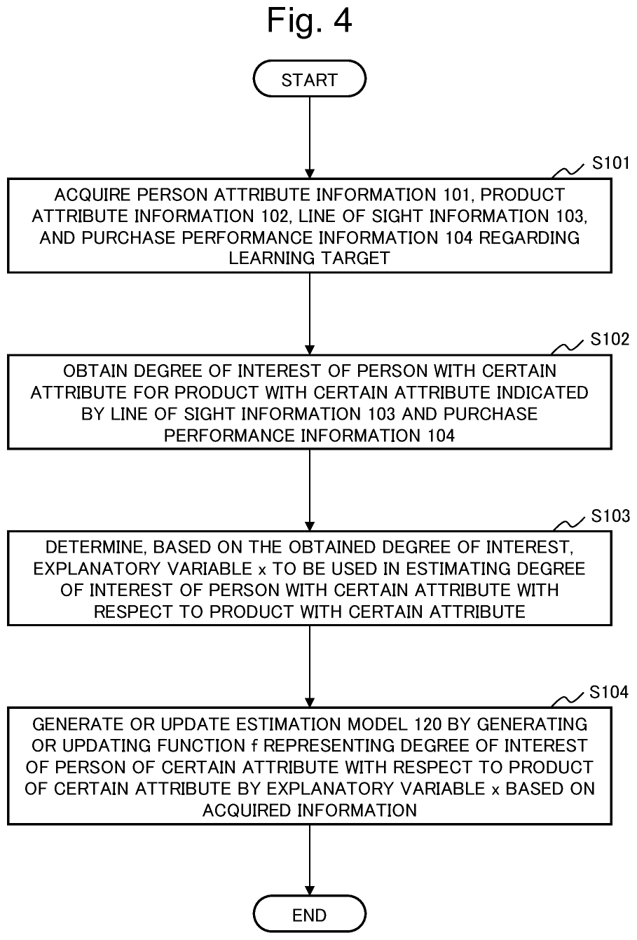

Next, an operation (processing) of generating the estimation model 120 (performing machine learning) by the purchasing factor estimation device 10 according to the present example embodiment will be described in detail with reference to a flowchart of FIG. 4.

The acquisition unit 11 acquires the person attribute information 101, the product attribute information 102, the line of sight information 103, and the purchase performance information 104 regarding the learning target from the outside (step S101). The generation unit 12 obtains a degree of interest of a person with a certain attribute in a product with a certain attribute indicated by the line of sight information 103 and the purchase performance information 104 (step S102).

Based on the obtained degree of interest, the generation unit 12 determines an explanatory variable x to be used in estimating the degree of interest of a person with a certain attribute in a product with a certain attribute (step S103). The generation unit 12 generates or updates the estimation model 120 by generating or updating the function f representing the degree of interest of the person with a certain attribute in the product with a certain attribute by the explanatory variable x based on the above-described information acquired by the acquisition unit 11 (step S104), and the entire processing ends.

<Operation of Estimating Degree of Interest of Estimation Target Person in Estimation Target Product>

Next, an operation in which the purchasing factor estimation device 10 according to the present example embodiment estimates the degree of interest of the estimation target person (first person) for the estimation target product (first product) using the estimation model 120 generated or updated as described above will be described.

The acquisition unit 11 acquires the person attribute information 101 related to the estimation target person and the product attribute information 102 related to the estimation target product from an external device.

Based on the person attribute information 101 and the product attribute information 102 acquired by the acquisition unit 11, the estimation unit 13 estimates the degree of interest of the estimation target person in the estimation target product using the estimation model 120.

The degree of interest is information indicating the interest of the customer in the target product. For example, the degree of interest includes presence or absence of interest, a level of interest in the target product (for example, three levels of interest: high, middle, and low), whether to purchase, and the like. The degree of interest may be a numerical value represented by evaluation on a scale of 10 or the like, a percentage, or the like.

For example, it is assumed that the estimation target person is the person A exemplified in FIG. 3 and the estimation target product is the product X. In this case, the estimation unit 13 specifies the value of the explanatory variable x included in the function f_{AX} illustrated in FIG. 3 from the attribute of the person A indicated by the person attribute information 101 and the attribute of the product X indicated by the product attribute information 102, and estimates the degree of interest of the person A in the product X using the specified value of the explanatory variable x and the function f_{AX}.

The estimation unit 13 notifies the output unit 14 of the result of estimating the degree of interest of the estimation target person in the estimation target product. The estimation reason generation unit 16 generates an estimation reason by the estimation unit 13, and notifies the output unit 14 of the generated estimation reason. The estimation reason represents, for example, the value of the explanatory variable x having a large degree of contribution in the above-described estimation of the degree of interest. The degree of contribution of each explanatory variable xᵢ is expressed, for example, as a coefficient of the explanatory variable xᵢ in the function f, and the larger the degree of contribution, the larger the value of the coefficient. The estimation reason generation unit 16 can obtain an estimation reason in estimation using an estimation model constructed by machine learning, for example, by using an existing technology related to explainable artificial intelligence (AI).

The output unit 14 outputs, to the management terminal device 20, the result of estimating the degree of interest of the estimation target person in the estimation target product notified from the estimation unit 13 and the estimation reason notified from the estimation reason generation unit 16. The output unit 14 may output the estimation result of the degree of interest and the estimation reason thereof as a file. The management terminal device 20 displays the information output from the output unit 14 on the display screen 200.

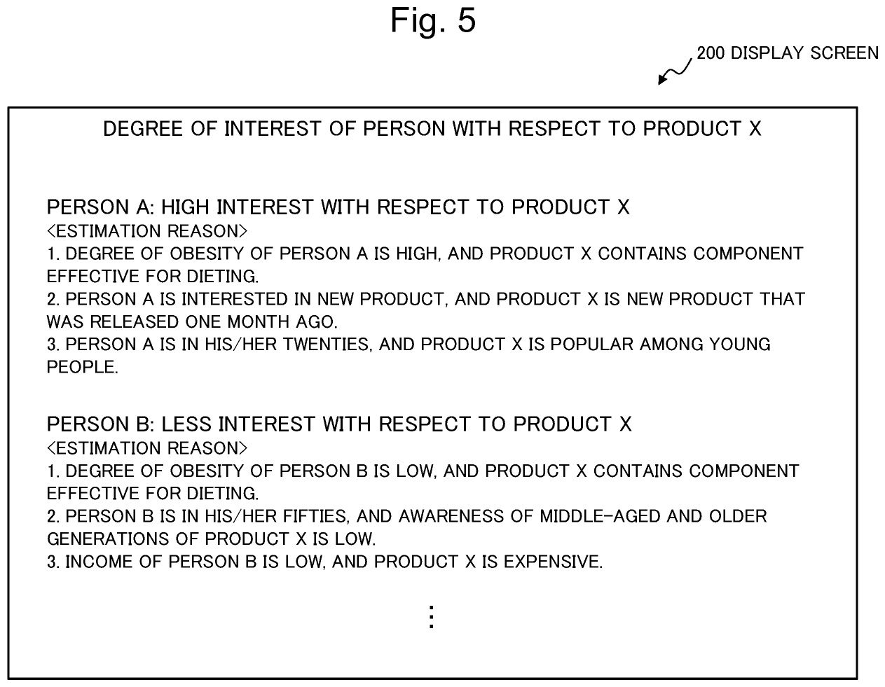

FIG. 5 is a diagram illustrating a mode in which the result of estimating the degree of interest of the estimation target person in the estimation target product and the estimation reason, which are output from the output unit 14 according to the present example embodiment, are displayed on the display screen 200.

In the example illustrated in FIG. 5, the management terminal device 20 displays on the display screen 200 that the interest of the person A in the product X is high as the estimation result by the estimation unit 13. Then, as an estimation reason, the management terminal device 20 displays, on the display screen 200, as follow:
“1. The degree of obesity of the person A is high, and the product X contains a component effective for dieting.”,
“2. The person A is interested in a new product, and the product X is a new product that was released one month ago.”,
“3. The person A is in his/her twenties, and the product X is popular among young people.”. For example, the management terminal device 20 may display the explanatory variable x having a large degree of contribution on the display screen 200 in order from the estimation reason.

In the example illustrated in FIG. 5, the management terminal device 20 displays on the display screen 200 that the interest of the person B in the product X is low and the estimation reason as the estimation result by the estimation unit 13.

The mode in which the result of estimating the degree of interest of the estimation target person in the estimation target product and the estimation reason are displayed on the display screen 200 is not limited to itemized writing using sentences as illustrated in FIG. 5. For example, the management terminal device 20 may display the magnitude of the degree of contribution for each estimation reason using a diagram illustrated in FIG. 3 or using a bar graph, a circular graph, or the like.

The estimation unit 13 may specify one or more persons whose degree of interest in a certain estimation target product satisfies a predetermined condition (for example, a threshold or more) in the estimation model 120, and extract attribute information of the specified person. Then, the management terminal device 20 may display the attribute information of the person extracted by the estimation unit 13 as described above on the display screen 200. For example, in a case where the level of interest of the person in the product X is a situation as illustrated in FIG. 5, the management terminal device 20 displays, for example, “The person having a high interest in the product X is a person having a high degree of obesity, a person having a high interest in a new product, and a person in his/her twenties.” on the display screen 200.

In a case where the generation unit 12 manages a plurality of persons included in the estimation model 120 as one group based on the grouping result by the grouping unit 15, the estimation unit 13 may estimate the degree of interest of the person by, for example, specifying a group including the estimation target person. The estimation unit 13 can specify in which group the person is included based on the person attribute information 101 regarding the person. Alternatively, when the acquisition unit 11 acquires the person attribute information 101 regarding the estimation target group, the estimation unit 13 may estimate the degree of interest in the estimation target product in units of groups instead of individuals.

When the acquisition unit 11 acquires line of sight information 103 on an estimation target person from an external device, the estimation unit 13 may estimate a degree of interest of the person in an estimation target product by using acquired line of sight information 103 and estimation model 120. In this case, the generation unit 12 generates or updates the estimation model 120 including the explanatory variable x related to the line of sight information 103. In this case, the output unit 14 displays, for example, “The person A watched the product X for 10 seconds in front of the product shelf.” on the display screen 200 as the estimation reason that the interest of the person A in the product X is high.

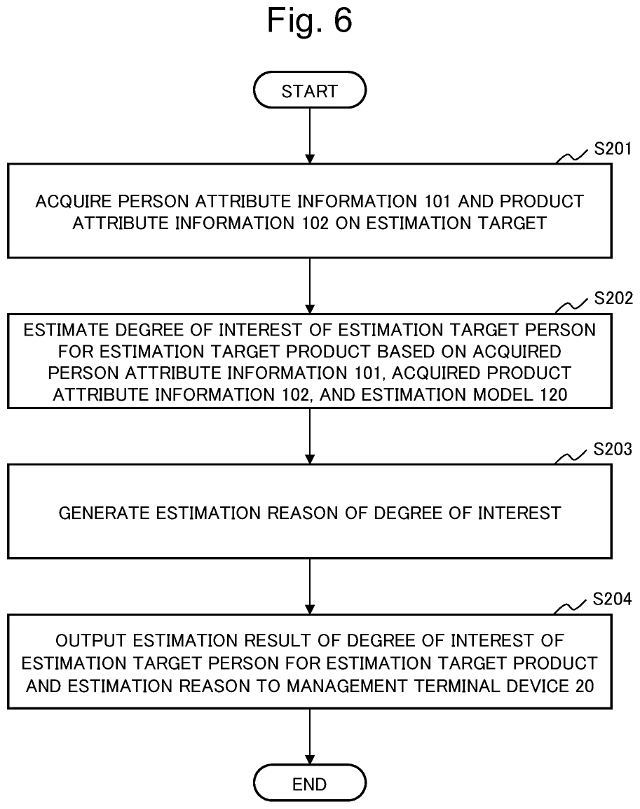

Next, an operation (processing) of estimating the degree of interest of the estimation target person in the estimation target product by the purchasing factor estimation device 10 according to the present example embodiment will be described in detail with reference to the flowchart of FIG. 6.

The acquisition unit 11 acquires the person attribute information 101 and the product attribute information 102 on the estimation target (step S201). The estimation unit 13 estimates the degree of interest of the estimation target person in the estimation target product based on the person attribute information 101 and the product attribute information 102 acquired by the acquisition unit 11 and the estimation model 120 (step S202). The estimation reason generation unit 130 generates an estimation reason of the degree of interest (step S203). The output unit 14 outputs the estimation result of the degree of interest of the estimation target person in the estimation target product by the estimation unit 13 and the estimation reason to the management terminal device 20 (step S204), and the entire processing ends.

Since the purchasing factor estimation device 10 according to the present example embodiment can identify a factor that a customer has purchased a product, it is possible to contribute to sales expansion of the product. This is because the purchasing factor estimation device 10 estimates the degree of interest of the estimation target using the estimation model 120 that has learned the relationship between the person attribute information 101 and the product attribute information 102, and the degree of interest of the person in the product represented by the line of sight information 103, and outputs the estimation reason.

Hereinafter, effects achieved by the purchasing factor estimation device 10 according to the present example embodiment will be described in detail.

For example, in planning a strategy for expanding sales of a new product or the like, it is very important to analyze factors greatly contributing to purchase of the new product in addition to what kind of attribute a person shows an interest in the new product. However, it is difficult to identify a factor that a customer has purchased a product, which may interfere with sales expansion of the product.

In order to solve such a problem, the purchasing factor estimation device 10 according to the present example embodiment includes the acquisition unit 11, the estimation unit 13, and the output unit 14, and operates as described above with reference to FIGS. 1 to 6, for example. That is, the acquisition unit 11 acquires the person attribute information 101 on the estimation target person (first person) and the product attribute information 102 on the estimation target product (first product). Based on the person attribute information 101 on the estimation target person and the product attribute information 102 on the estimation target product, the estimation unit 13 estimates the degree of interest of the estimation target person in the estimation target product using the estimation model 120. The output unit 14 outputs the estimated degree of interest of the estimation target person and the estimation reason. The estimation model 120 is a model generated by learning the relationship among the person attribute information 101 on the learning target person (second person), the product attribute information 102 on the learning target product (second product), and the line of sight information 103 on the learning target person in the learning target product, and the degree of interest of the learning target person in the learning target product.

That is, the purchasing factor estimation device 10 according to the present example embodiment estimates the degree of interest of the estimation target person in the estimation target product using the estimation model 120 that has learned the relationship among the person attribute information 101 and the product attribute information 102 and the degree of interest of the person in the product represented by the line of sight information 103, and outputs the estimation reason. As a result, the purchasing factor estimation device 10 can identify the factor by which the customer has purchased the product, and thus can contribute to the expansion of product sales.

The purchasing factor estimation device 10 according to the present example embodiment outputs attribute information regarding the estimation target person such that the degree of interest of the estimation target person satisfies a predetermined condition. As a result, the purchasing factor estimation device 10 can easily present to the user what kind of attribute the person has a high interest in the target product.

The purchasing factor estimation device 10 according to the present example embodiment has a function of grouping (clustering) the learning and estimation target persons based on the degrees of interest of the learning and estimation target persons in the product. As a result, since the purchasing factor estimation device 10 collectively handles persons having similar characteristics of the degree of interest in the product, it is possible to efficiently estimate the purchasing factor.

The learning and estimation target products by the purchasing factor estimation device 10 according to the present example embodiment may be new products. Then, the estimation model 120 may be a model learned regarding a learning target product displayed on a product shelf together with a competitive product that is a popular product whose sales performance is equal to or more than a standard (for example, a threshold). In this case, the purchasing factor estimation device 10 learns the degree of interest of the consumer in the new product using the line of sight information 103 of the consumer (person) in a state where the new product is displayed on the product shelf together with the competing product that is popular. As a result, the purchasing factor estimation device 10 can appropriately support the analysis of the competitiveness of the new product against the best-selling competing product by the company that has developed the new product.

The function implemented by the purchasing factor estimation device 10 according to the present example embodiment described above may be implemented by a system including a plurality of information processing devices.

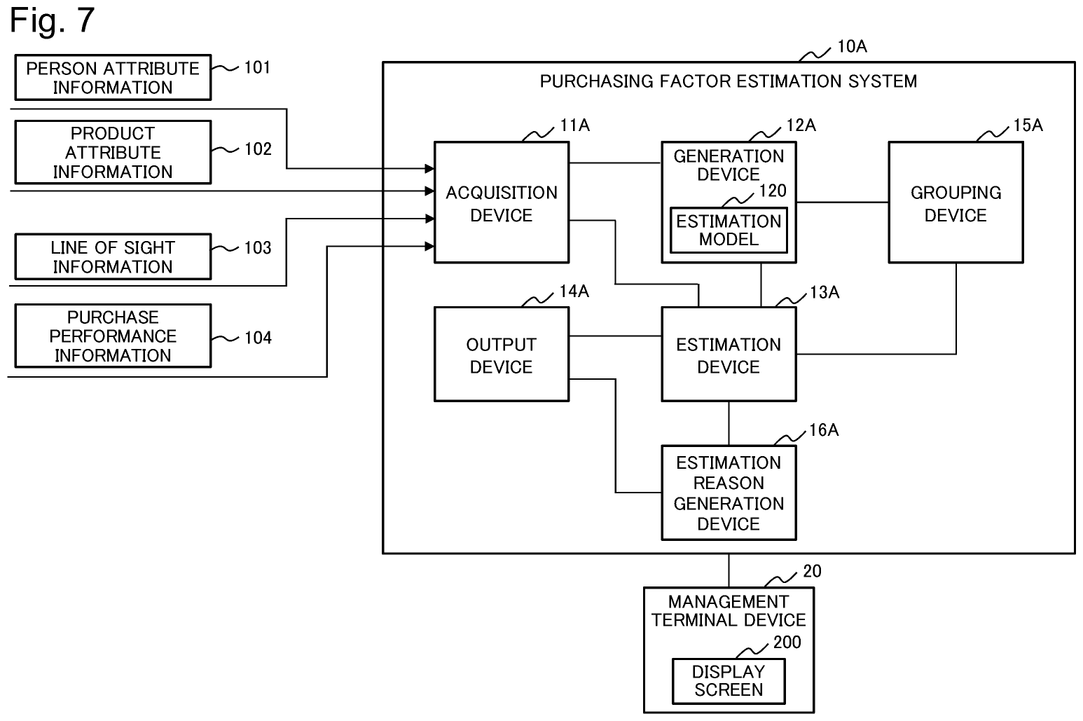

FIG. 7 is a block diagram illustrating a configuration of a purchasing factor estimation system 10A according to a modification of the present example embodiment. The function of the purchasing factor estimation system 10A is equivalent to that of the purchasing factor estimation device 10 described above. The purchasing factor estimation system 10A includes an acquisition device 11A, a generation device 12A, an estimation device 13A, an output device 14A, a grouping device 15A, and an estimation reason generation device 16A, each of which is an information processing device. The acquisition device 11A, the generation device 12A, the estimation device 13A, the output device 14A, the grouping device 15A, and the estimation reason generation device 16A sequentially have functions equivalent to those of the acquisition unit 11, the generation unit 12, the estimation unit 13, the output unit 14, the grouping unit 15, and the estimation reason generation unit 16 described above. The acquisition device 11A, the generation device 12A, the estimation device 13A, the output device 14A, the grouping device 15A, and the estimation reason generation device 16A are communicably connected to each other.

The configuration of the purchasing factor estimation system 10A is not limited to the configuration including the information processing device corresponding to each component of the purchasing factor estimation device 10. For example, the purchasing factor estimation system 10A may include a plurality of components of the purchasing factor estimation device 10 as one information processing device.

### Second Example Embodiment

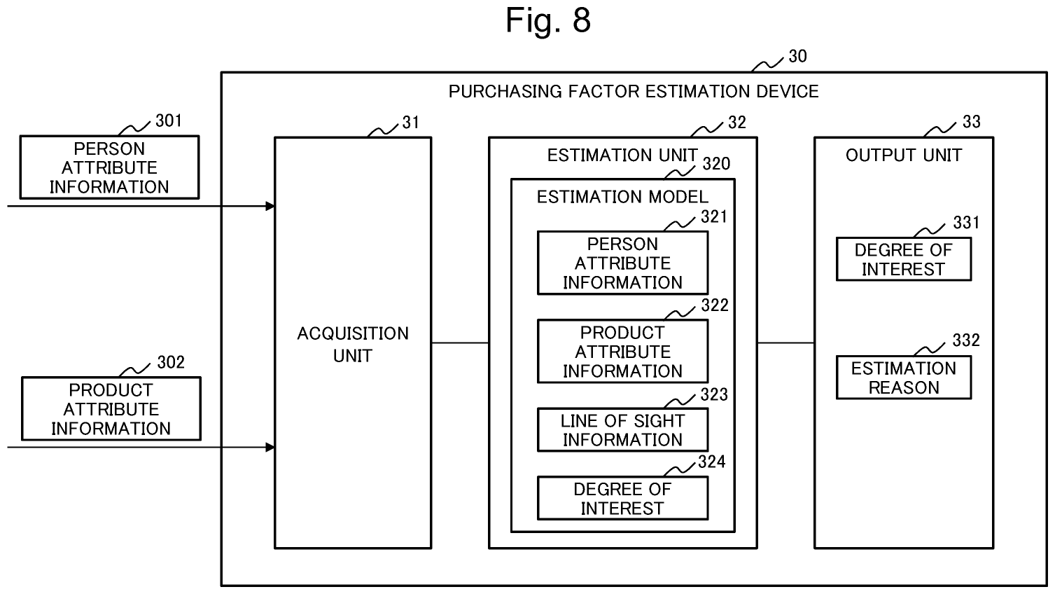

FIG. 8 is a block diagram illustrating a configuration of a purchasing factor estimation device 30 according to a second example embodiment of the present invention. The purchasing factor estimation device 30 includes an acquisition unit 31, an estimation unit 32, and an output unit 33. However, the acquisition unit 31, the estimation unit 32, and the output unit 33 are an example of an acquisition means, an estimation means, and an output means in order.

The acquisition unit 31 acquires person attribute information 301 on the first person (the estimation target person) and product attribute information 302 on the first product (the estimation target product). The person attribute information 301 is, for example, information similar to the person attribute information 101 regarding the estimation target person according to the first example embodiment. The product attribute information 302 is, for example, information similar to the product attribute information 102 regarding the estimation target product according to the first example embodiment. The acquisition unit 31 operates similarly to the acquisition unit 11 according to the first example embodiment, for example.

The estimation unit 32 estimates a degree of interest 331 of the first person in the first product using the estimation model 320 based on person attribute information 301 regarding the first person and the product attribute information 302 regarding the first product. The estimation model 320 is, for example, a model similar to the estimation model 120 according to the first example embodiment. The estimation unit 32 operates similarly to the estimation unit 13 according to the first example embodiment, for example.

The output unit 33 outputs the estimated degree of interest 331 of the first person and estimation reason 332. The output unit 33 operates similarly to the output unit 14 according to the first example embodiment, for example.

The estimation model 320 is generated by learning a relationship among person attribute information 321 on the second person (learning target person), product attribute information 322 on the second product (learning target product), line of sight information 323 of the second person for the second product, and a degree of interest 324 of the second person in the second product. The person attribute information 321 is, for example, information similar to the person attribute information 101 regarding the learning target person according to the first example embodiment. The product attribute information 322 is, for example, information similar to the product attribute information 102 regarding the learning target product according to the first example embodiment. The line of sight information 323 is, for example, information similar to the line of sight information 103 regarding the learning target person according to the first example embodiment. The degree of interest 324 is obtained from the line of sight information 323, for example, similarly to the first example embodiment. The estimation model 320 is generated by, for example, a procedure similar to that in which the generation unit 12 according to the first example embodiment generates the estimation model 120.

Since the purchasing factor estimation device 30 according to the present example embodiment can identify a factor that a customer has purchased a product, it is possible to contribute to sales expansion of the product. This is because the purchasing factor estimation device 30 estimates the degree of interest 331 of the estimation target using the estimation model 320 that has learned the relationship among the person attribute information 321, the product attribute information 322, and the degree of interest 324 of the person in the product represented by the line of sight information 323, and outputs the estimation reason 332.

### Hardware Configuration Example

Each unit in the purchasing factor estimation device 10 illustrated in FIG. 1 or the purchasing factor estimation device 30 illustrated in FIG. 7 in each of the above-described example embodiments can be achieved by dedicated hardware (HW) (electronic circuit). In FIGS. 1 and 7, at least the following configuration can be regarded as a function (processing) unit (software module) of a software program.
Acquisition units 11 and 31,
Generation unit 12
Estimation units 13 and 32,
Output units 14 and 33,
Grouping unit 15,
Estimation reason generation unit 16.

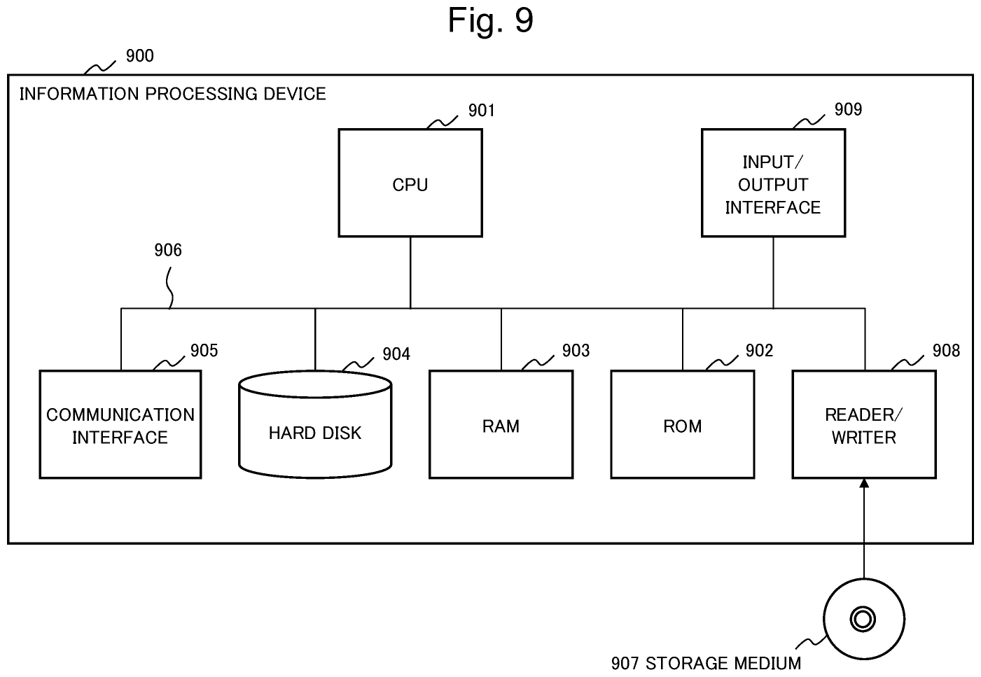

However, the division of each unit illustrated in these drawings is a configuration for convenience of description, and various configurations can be assumed at the time of implementation. An example of a hardware environment in this case will be described with reference to FIG. 9.

FIG. 9 is a diagram exemplarily describing a configuration of an information processing device 900 (computer system) capable of achieving the purchasing factor estimation device 10 according to the first example embodiment or the purchasing factor estimation device 30 according to the second example embodiment of the present invention. That is, FIG. 9 illustrates a configuration of at least one computer (information processing device) capable of achieving the purchasing factor estimation devices 10 and 30 illustrated in FIGS. 1 and 7, and illustrates a hardware environment capable of achieving each function in the above-described example embodiment.

The information processing device 900 illustrated in FIG. 8 includes the following hardware as components, but may not include some of the following components.
CPU (Central_Processing_Unit) 901,
ROM (Read_Only_Memory) 902,
RAM (Random_Access_Memory) 903,
Hard disk (storage device) 904,
Communication interface 905 with external device,
Bus 906 (communication line),
Reader/writer 908 capable of reading and writing data stored in storage medium 907 such as CD-ROM (Compact_Disc_Read_Only_Memory),
Input/output interface 909 such as monitor, speaker, or keyboard.

That is, the information processing device 900 including the above-described components is a general computer to which these components are connected via the bus 906. The information processing device 900 may include a plurality of CPUs 901 or may include a CPU 901 configured by multiple cores. The information processing device 900 may include a GPU (Graphical_Processing_Unit) (not illustrated) in addition to the CPU 901.

Then, the present invention described using the above-described example embodiment as an example supplies a computer program capable of achieving the following functions to the information processing device 900 illustrated in FIG. 9. The function is the above-described configuration in the block configuration diagram (FIGS. 1 and 7) referred to in the description of the example embodiment or the function of the flowchart (FIGS. 4 and 6). Thereafter, the present invention is achieved by reading, interpreting, and executing the computer program on the CPU 901 of the hardware. The computer program supplied into the device may be stored in a readable/writable volatile memory (RAM 903) or a nonvolatile storage device such as the ROM 902 or the hard disk 904.

In the above case, a general procedure can be adopted at present as a method of supplying the computer program into the hardware. Examples of the procedure include a method of installing the program in the apparatus via various storage media 907 such as a CD-ROM, a method of downloading the program from the outside via a communication line such as the Internet, and the like. In such a case, the present invention can be understood to be constituted by a code constituting the computer program or the storage medium 907 storing the code.

The present invention has been described above using the above-described example embodiments as schematic examples. However, the present invention is not limited to the above-described example embodiments. That is, the present invention can apply various aspects that can be understood by those of ordinary skill in the art without departing from the spirit and scope of the present invention.

Note that some or all of the above-described example embodiments can also be described as the following supplementary notes. However, the present invention exemplarily described by the above-described example embodiments is not limited to the following.

(Supplementary Note 1)

A purchasing factor estimation device including:
an acquisition means configured to acquire person attribute information on a first person and product attribute information on a first product;
an estimation means configured to estimate a degree of interest of the first person in the first product using an estimation model based on the person attribute information on the first person and the product attribute information on the first product; and
an output means configured to output the estimated degree of interest of the first person and an estimation reason,
wherein
the estimation model is generated by learning a relationship among person attribute information on a second person, product attribute information on a second product, line of sight information of the second person for the second product, and a degree of interest of the second person in the second product.

(Supplementary Note 2)

The purchasing factor estimation device according to Supplementary Note 1, wherein
the output means outputs at least one of the person attribute information on the first person and the product attribute information on the first product as the estimation reason.

(Supplementary Note 3)

The purchasing factor estimation device according to Supplementary Note 1 or 2, wherein
the attribute information on the first and second persons includes at least one of age, sex, occupation, income, nationality, family structure, hobby, place of residence, body shape, drinking, smoking, preference, and behavior history of the first and second persons.

(Supplementary Note 4)

The purchasing factor estimation device according to any one of Supplementary Notes 1 to 3, wherein
the attribute information on the first and second products includes at least one of product name, product identifier, type, quantity, price, appearance, manufacturer, seller, content, nutritional component display, raw material, release time, and display position of the first and second products.

(Supplementary Note 5)

The purchasing factor estimation device according to any one of Supplementary Notes 1 to 4, wherein
the output means outputs the attribute information on the first person such that the degree of interest of the first person satisfies a predetermined condition.

(Supplementary Note 6)

The purchasing factor estimation device according to any one of Supplementary Notes 1 to 5, wherein
the acquisition means acquires line of sight information of the first person for the first product,
the estimation means estimates the degree of interest of the first person in the first product using the estimation model based on the line of sight information of the first person for the first product, and
the output means outputs the estimation reason based on the line of sight information of the first person.

(Supplementary Note 7)

The purchasing factor estimation device according to any one of Supplementary Notes 1 to 6, further including:
a grouping means configured to group the first and second persons based on the degrees of interest of the first and second persons.

(Supplementary Note 8)

The purchasing factor estimation device according to any one of Supplementary Notes 1 to 7, further including:
a generation means configured to generate the estimation model based on the relationship among the person attribute information on the second person, the product attribute information on the second product, and the line of sight information of the second person for the second product, and the degree of interest of the second person in the second product.

(Supplementary Note 9)

The estimation model is a model obtained by learning a relationship among the person attribute information on the second person, the product attribute information on the second product, and whether the second person has purchased the second product.

The purchasing factor estimation device according to any one of Supplementary Notes 1 to 8.

(Supplementary Note 10)

The purchasing factor estimation device according to any one of Supplementary Notes 1 to 9, wherein
the first and second products are new products, and
the estimation model is a model obtained by learning the second product displayed together with a product whose sales performance is equal to or more than a reference.

(Supplementary Note 11)

A purchasing factor estimation system including:
an acquisition means configured to acquire person attribute information on a first person and product attribute information on a first product;
an estimation means configured to estimate a degree of interest of the first person in the first product using an estimation model based on the person attribute information on the first person and the product attribute information on the first product; and
an output means configured to output the estimated degree of interest of the first person and an estimation reason,
wherein
the estimation model is generated by learning a relationship among person attribute information on a second person, product attribute information on a second product, line of sight information of the second person for the second product, and a degree of interest of the second person in the second product.

(Supplementary Note 12)

A purchasing factor estimation method performed by an information processing device, the method including:
acquiring person attribute information on a first person and product attribute information on a first product;
estimating a degree of interest of the first person in the first product using an estimation model based on the person attribute information on the first person and the product attribute information on the first product; and
outputting the estimated degree of interest of the first person and an estimation reason,
wherein
the estimation model is generated by learning a relationship among person attribute information on a second person, product attribute information on a second product, line of sight information of the second person for the second product, and a degree of interest of the second person in the second product.

(Supplementary Note 13)

A storage medium having storage therein a purchasing factor estimation program causing a computer to execute:
acquiring person attribute information on a first person and product attribute information on a first product;
estimating a degree of interest of the first person in the first product using an estimation model based on the person attribute information on the first person and the product attribute information on the first product; and
outputting the estimated degree of interest of the first person and an estimation reason,
wherein
the estimation model is generated by learning a relationship among person attribute information on a second person, product attribute information on a second product, line of sight information of the second person for the second product, and a degree of interest of the second person in the second product.

### REFERENCE SIGNS LIST

10 purchasing factor estimation device
10A purchasing factor estimation system
101 person attribute information
102 product attribute information
103 line of sight information
104 purchase performance information
11 acquisition unit
11A acquisition device
12 generation unit
12A generating device
120 estimation model
13 estimation unit
13A estimation device
14 output unit
14A output device
15 grouping unit
15A grouping device
16 estimation reason generation unit
16A estimation reason generation device
20 management terminal device
200 display screen
30 purchasing factor estimation device
301 person attribute information
302 product attribute information
31 acquisition unit
32 estimation unit
320 estimation model
321 person attribute information
322 product attribute information
323 line of sight information
324 degree of interest
33 output unit
331 degree of interest
332 estimation reason
900 information processing device
901 CPU
902 ROM
903 RAM
904 hard disk (storage device)
905 communication interface
906 bus
907 storage medium
908 reader/writer
909 input/output interface

What is claimed is:

1. A purchasing factor estimation device comprising:
at least one memory storing a computer program; and
at least one processor configured to execute the computer program to
acquire person attribute information on a first person and product attribute information on a first product;
estimate a degree of interest of the first person in the first product using an estimation model based on the person attribute information on the first person and the product attribute information on the first product; and
output the estimated degree of interest of the first person and an estimation reason,
wherein
the estimation model is generated by learning a relationship among person attribute information on a second person, product attribute information on a second product, line of sight information of the second person for the second product, and a degree of interest of the second person in the second product.

2. The purchasing factor estimation device according to claim 1, wherein the processor is configured to execute the computer program to
output at least one of the person attribute information on the first person and the product attribute information on the first product as the estimation reason.

3. The purchasing factor estimation device according to claim 1, wherein
the attribute information on the first and second persons includes at least one of age, sex, occupation, income, nationality, family structure, hobby, place of residence, body shape, drinking, smoking, preference, and behavior history of the first and second persons.

4. The purchasing factor estimation device according to claim 1, wherein
the attribute information on the first and second products includes at least one of product name, product identifier, type, quantity, price, appearance, manufacturer, seller, content, nutritional component display, raw material, release time, and display position of the first and second products.

5. The purchasing factor estimation device according to claim 1, wherein the processor is configured to execute the computer program to
output the attribute information on the first person such that the degree of interest of the first person satisfies a predetermined condition.

6. The purchasing factor estimation device according to claim 1, wherein the processor is configured to execute the computer program to
acquire line of sight information of the first person for the first product,
estimate the degree of interest of the first person in the first product using the estimation model based on the line of sight information of the first person for the first product, and
output the estimation reason based on the line of sight information of the first person.

7. The purchasing factor estimation device according to claim 1, wherein the processor is configured to execute the computer program to
group the first and second persons based on the degrees of interest of the first and second persons.

8. The purchasing factor estimation device according to claim 1, wherein the processor is configured to execute the computer program to
generate the estimation model based on the relationship among the person attribute information on the second person, the product attribute information on the second product, and the line of sight information of the second person for the second product, and the degree of interest of the second person in the second product.

9. The purchasing factor estimation device according to claim 1, wherein
the estimation model is a model obtained by learning a relationship among the person attribute information on the second person, the product attribute information on the second product, and whether the second person has purchased the second product.

10. The purchasing factor estimation device according to claim 1, wherein
the first and second products are new products, and
the estimation model is a model obtained by learning the second product displayed together with a product whose sales performance is equal to or more than a reference.

11. (canceled)

12. A purchasing factor estimation method performed by an information processing device, the method comprising:
acquiring person attribute information on a first person and product attribute information on a first product;
estimating a degree of interest of the first person in the first product using an estimation model based on the person attribute information on the first person and the product attribute information on the first product; and
outputting the estimated degree of interest of the first person and an estimation reason,
wherein
the estimation model is generated by learning a relationship among person attribute information on a second person, product attribute information on a second product, line of sight information of the second person for the second product, and a degree of interest of the second person in the second product.

13. A non-transitory computer-readable storage medium having storage therein a purchasing factor estimation program causing a computer to execute:
acquiring person attribute information on a first person and product attribute information on a first product;
estimating a degree of interest of the first person in the first product using an estimation model based on the person attribute information on the first person and the product attribute information on the first product; and
outputting the estimated degree of interest of the first person and an estimation reason,
wherein
the estimation model is generated by learning a relationship among person attribute information on a second person, product attribute information on a second product, line of sight information of the second person for the second product, and a degree of interest of the second person in the second product.
